(19) United States
(12) Patent Application Publication
(10) Pub. No.: US 2002/0166391 A1
(43) Pub. Date: Nov. 14, 2002

(54) Method and system for in-line sample extraction

(76) Inventors: Khalid Mahmood Khan, Middletown, NY (US); Srinivas R. Gadiraju, Randolph, NJ (US)

Correspondence Address: Charles W. Ashbrook, Warner-Lambert Company, 2800 Plymouth Road, Ann Arbor, MI, 48105, US

(21) Appl. No.: 10/115,889

(22) Filed: Apr. 4, 2002

Related U.S. Application Data
(60) Provisional application No. 60/281,755, filed on Apr. 5, 2001.

(51) Int. Cl. G01N 1/00; G01N 15/00

(52) U.S. Cl. 73/863.61; 73/865.5

(57) ABSTRACT

A device, system and method for bypassing and/or testing a sample of a material flowing in a direction along a flowpath utilizes a sleeve having open ends and defining a duct adapted for insertion into the flowpath and a sidewall. An inlet conduit attached to the sleeve has an inlet section at one end, and an outlet conduit attached to the sleeve has an outlet section. The sample is returned through the outlet conduit in a direction substantially parallel to the direction of the material flowing through the sleeve.

### FIELD OF THE INVENTION

The present invention pertains to an apparatus and method for the continuous measurement of particle size and concentration distributions from a conveyed stream of a powdered material, such as an active pharmaceutical ingredient.

### BACKGROUND OF THE INVENTION

In order to maintain the strict quality control standards necessary during pharmaceutical product manufacture, in-line particle concentration and size measurement devices and systems are designed to continuously measure and provide particle size and concentration distributions from a pneumatically conveyed stream of powdered active ingredient. Typically, such instruments use laser diffraction technology to measure the particle size distributions by measuring the variation in ensemble angular scattering (EAS) as a function of particle size for a group (ensemble) of particles. These measurement devices have the capability for high concentration measurements with improved performance for particle concentrations ranging from 1 gm/M³ up to 10,000 gm/m³.

Among particle size measurement devices of the prior art are those available from various in-line particle size analyzer manufacturers, such as the Insitec® EPCS-EB (Ensemble Particle Concentration and Size-Eductor Style) in-line particle size analyzer. These analyzers are typically connected to a pipe or other conduit of a processing apparatus through which a powdered material flows. The measurement devices withdraw a sample to be analyzed at the inlet port and typically return the sample to the pipe or conduit.

The connection of the analyzer typically requires puncturing of the pipe through which powdered material flows, manual insertion of both the inlet and outlet ports into the pipe and then sealing the area around the puncture. Once installed, however, these particle size measurement devices are difficult to uninstall and reconnect to other pipes or conduits for subsequent use in other processing apparatus because of the seal formed around the puncture as well as the requirement that the holes formed by puncturing the pipes must also be sealed.

Notwithstanding the foregoing, the present inventors have developed a modular interface wherein a particle size measurement device can be removeably interfaced with a mill or other particle processing apparatus (e.g., a roller compactor) and simultaneously provide enhanced accuracy of particle size analysis of a material flowing through the apparatus.

### SUMMARY OF THE INVENTION

The present invention provides an in-line device for extracting and returning a sample of a substance or powdered material, typically an active pharmaceutical ingredient, (hereafter “material”) flowing through a mill or similar processing apparatus. By positioning the device of the present invention in the flowpath of the material, a particle size measurement device can be successfully interfaced with the mill to provide enhanced accuracy particle size and particle concentration analysis of the material.

Typically, the device of the present invention provides a sleeve having open ends and a sidewall, which when combined define a duct adapted for insertion into the flowpath of a material. As the material flows through the duct, a representative sample of the material to be measured is drawn into an inlet conduit attached to the sleeve. The inlet conduit has an inlet section at one end, which defines an inlet port for withdrawing the sample of the material.

The particle concentration and particle size of the withdrawn sample is then measured in a manner as required by the skilled artisan to determine the particle size distribution. Subsequently, the analyzed sample is returned to the flow stream via an outlet conduit. The outlet conduit is also attached to the sleeve and has an outlet section at one end. The outlet section preferably has a portion extending parallel to the direction of the flow of the material flowing through the duct. The outlet section is also preferably positioned downstream from the inlet section.

By returning the sample to the flowpath in substantially the same direction as the flow of the material flowing through the duct, there is minimal disturbance of the material flowing through the duct. Therefore, disturbance of the material flowing into the inlet conduit is minimized, thereby improving and enhancing the accuracy of the results.

The invention is also modular in that the interface (including the duct) can be easily moved and switched between different processing apparatus by removing the entire interface from the flowpath and repositioning the interface in another material flowpath. The modular nature of the present invention also eliminates the need to puncture, manually insert and seal an extraction tip and exit port in the flowpath of a different processing apparatus.

The present invention is also directed to a system for bypassing/extracting and testing a sample of a material flowing in a direction along a flowpath, typically comprising the apparatus above and further an analyzer, connected between the inlet conduit and the outlet conduit, for measuring the particle size of the sample.

Additionally, the present invention is directed to a method for bypassing/extracting a sample of a material flowing in a direction along a flowpath, comprising the steps of withdrawing the sample of the material from the flowpath and returning the sample to the flowpath in an outlet conduit having an outlet section, wherein the outlet section has a portion extending substantially parallel to the direction of the flowpath and defines an outlet port for returning the sample of the material to the flowpath.

It is to be understood that both the foregoing general description and the following detailed description are exemplary, but are not restrictive, of the invention.

### BRIEF DESCRIPTION OF THE DRAWINGS

The invention is best understood from the following detailed description when read in connection with the accompanying drawing, in which

FIG. 1 is a diagram of the prior art. In particular, the figure shows the standard setup of an Insitec® in-line particle size analyzer.

FIG. 2 is a schematic view of the present invention in a measuring system.

FIG. 3 is a perspective skewed top down view of the present invention.

FIG. 4 is a partial cut away view of the circular region as shown in FIG. 2.

### DETAILED DESCRIPTION OF THE INVENTION, THE DRAWINGS AND PREFERRED EMBODIMENT

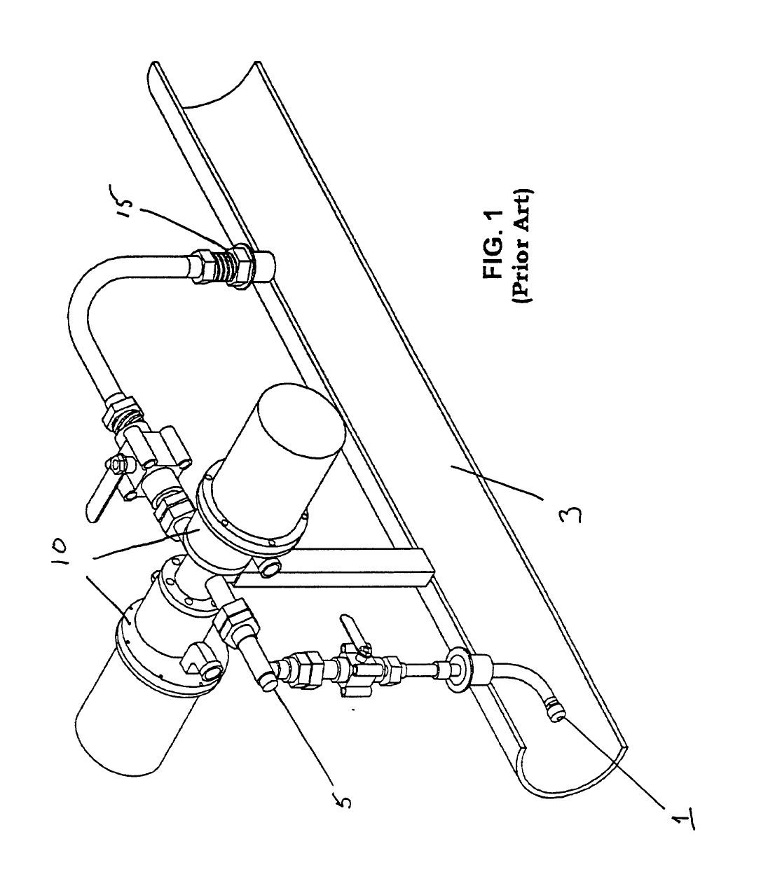

A prior art system is shown in FIG. 1. In order for that measurement device to function, a representative sample of a powder material to be analyzed is drawn into a bypass/dilution mechanism through a sample extraction tip 1. The sample extraction tip 1 is positioned in the flowpath of the powder material as it flows through a duct 3. The sampled material is then aerosolized with compressed air (eductor air) 5 to form a uni-particulate suspension. The suspended particles pass through a perpendicular laser beam in the optical head of the measurement device 10. The laser light scattered by the particles is focused at an array of annular detector rings by a lens (not shown). The signal of diffracted light is transformed into particle size distribution data and displayed on a monitor (not shown). The analyzed sample is subsequently returned to the flowpath via an outlet conduit 15.

Although useful, the above-described system is not designed to achieve a modular interface with a mill or other processing apparatus for particle size and particle concentration analysis of a material. Specifically, once extraction tip 1, outlet conduit 15, and measurement device 10 are connected to duct 3, much time and effort is required to reconfigure the system on another duct because the interface between extraction tip 1 and duct 3 is sealed.

Additionally, the above-described system may suffer from accuracy deficiencies. More particularly, the above described system returns the sample in a direction perpendicular to the flow of material through duct 3, disrupting the flow of the material through duct 3. Disruption of the flow of the material through duct 3 may disturb the flow of the material over the sample extraction tip 1, thereby affecting the accuracy of the results of tests performed on the withdrawn sample.

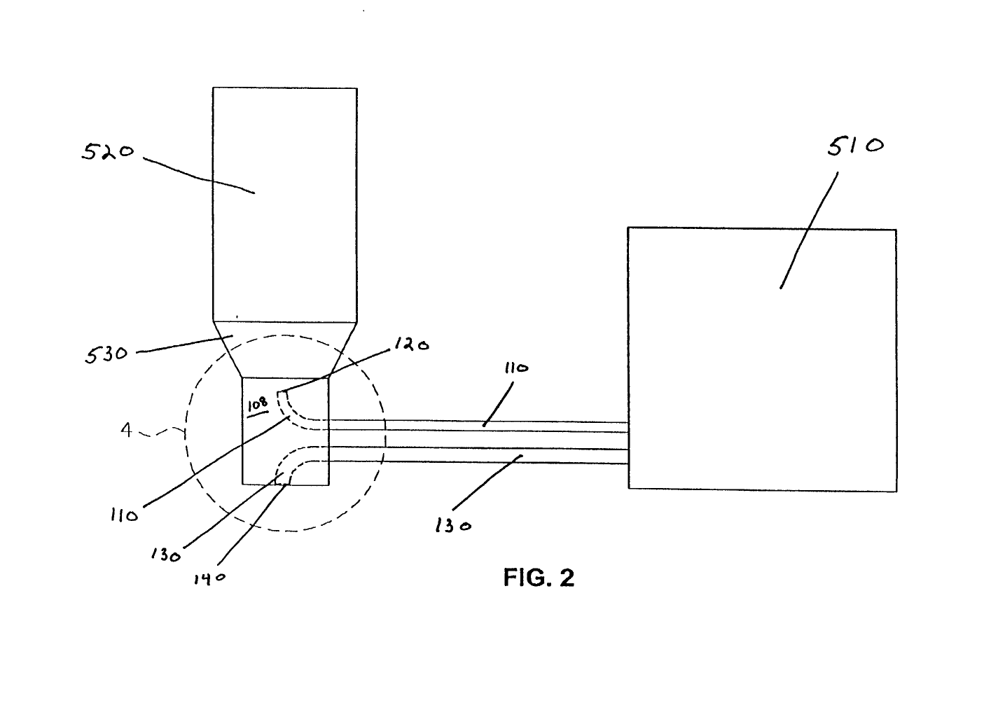

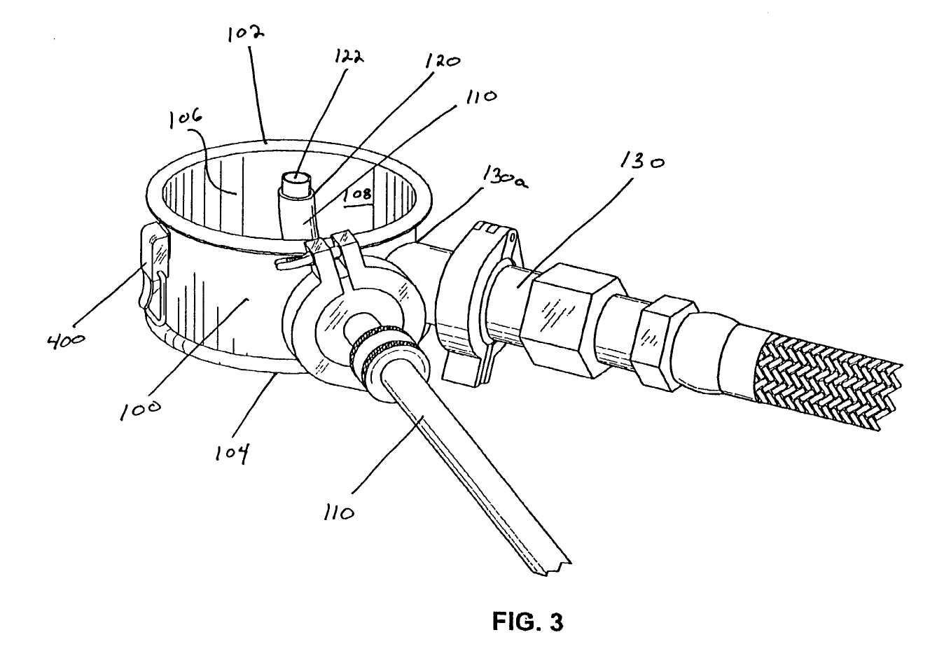

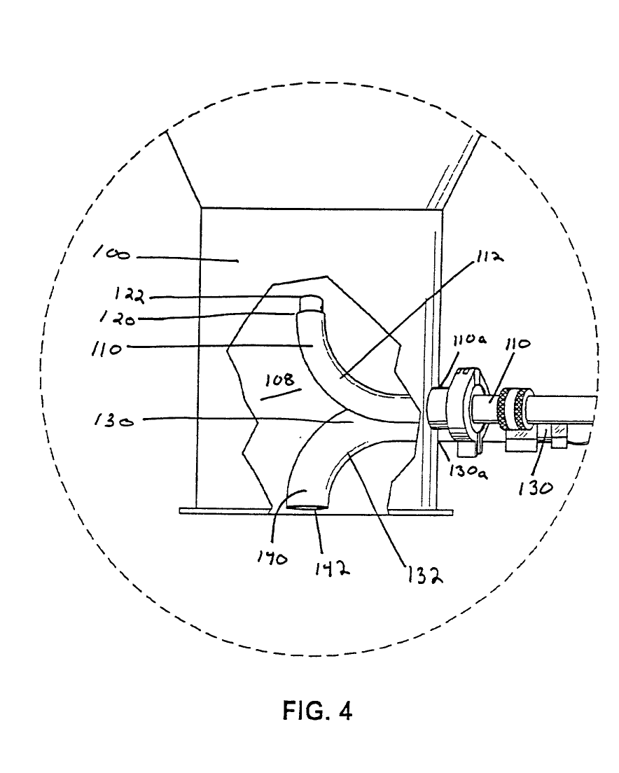

The present invention overcomes the deficiencies in the prior art by providing a mobile device for extracting and returning a sample of a material, typically an active pharmaceutical ingredient, (hereafter “material”) flowing in a direction along a flowpath, represented in FIG. 3. In the embodiment shown in FIG. 3, the device comprises (1) a sleeve 100, (2) an inlet conduit 110 (typically a length of tubing) connected to sleeve 100 and having an inlet section 120 (which may be a hole, nozzle or some other known form) at one end and (3) an outlet conduit 130 (typically a length of tubing) connected to sleeve 100 and having an outlet section 140 (shown in FIGS. 2 and 4) at one end.

Sleeve 100 typically has at least two open ends, open upstream end 102 and open downstream end 104, and a sidewall 106. The open ends and sidewall 106 define a duct 108 adapted for insertion into a flowpath of a material.

The shape of sleeve 100 can vary from cylindrical, rectangular, square or oval, although cylindrical is preferred. Typically, sleeve 100 is shaped to facilitate the positioning of the sleeve in the flowpath. Thus, the sleeve typically approximates the shape of the material exit of the material processing apparatus so that a secure interface can be formed, as shown on FIG. 2. Sleeve 100 may be further adapted to provide latches 400 to secure the interface of the sleeve 100 with the processing apparatus, as shown in FIG. 3.

If sleeve 100 is of cylindrical or similar shape, the overall length of sleeve 100 may be from about 0.5 to 10 diameters of sleeve 100. Preferably, the overall length of the sleeve is about 0.5 to 1.5 diameters of sleeve 100. Additionally, sleeve 100 may also have at least one end tapered or threaded to facilitate an interface between sleeve 100 and a processing apparatus.

Inlet section 120 defines an inlet port 122 for withdrawing a sample of material flowing through sleeve 100. The shape of inlet port 122 can vary depending upon the material to be sampled. Preferably, the inlet port 122 is circular or oval in shape although other shapes and forms may be suitable. Inlet conduit 110 is preferably removably coupled to sleeve 100 at inlet conduit attachment point 110a. The ratio of the cross section of inlet port 122 to the cross section of the sleeve 100 is in the range of 1:5 to 1:100, respectively.

Furthermore, outlet conduit 130 is preferably removably coupled to sleeve 100 at outlet conduit attachment point 130a. Outlet conduit 130 also has an outlet section 140 at one end. Outlet section 140 also defines an outlet port 142 for returning the sample of the material to the flowpath. Similar to above, the shape and form of outlet port 142 can vary depending upon the material to be sampled. Preferably, the outlet port 142 is circular or oval in shape. Dimensionally, the typical ratio of the cross section of inlet port 122 to outlet port 142 is in the range of 1:1 to 1:20, respectively. Preferably, the ratio of the cross section of inlet port 122 to outlet port 142 is about 3:10, respectively.

The material to be tested moves through inlet conduit 110 and outlet conduit 130 as a result of eductor pressure, gravity or other motive force. Typically eductor pressure is used to provide the material motive force.

Preferably, inlet conduit 110 and outlet conduit 130 are bent inside duct 108, as shown in FIGS. 2, 3 and 4. Inlet conduit 110 is bent to face in an upstream direction of the flowpath forming bent portion 112 of inlet conduit 110, and outlet conduit 130 is bent to face a downstream direction of the flowpath forming a bent portion 132 of outlet conduit 130.

In a typical embodiment, inlet section 120 and outlet section 140 extend substantially parallel to the direction of the flowpath through sleeve 100. In the preferred embodiment, at least one of outlet section 140 and inlet section 120 extend completely parallel to the flowpath through the sleeve. The length of inlet section 120 is typically equal to at least one diameter of the inlet conduit 110.

Similarly, the length of outlet section 140 is typically at least one diameter of outlet conduit 130. Preferably, the length of outlet section 140 is at least three diameters of outlet conduit 130. Because outlet section 140, which is adjacent bent portion 132, extends parallel to the direction of the flow of the material flowing through duct 108 in the preferred embodiment, the sample material exiting the outlet section re-enters the flowpath flowing in substantially the same direction as the flow of the material flowing through the duct. Thus, there is minimal disturbance of the material flowing through duct 108, and therefore there is minimal disturbance of the material flowing into the inlet section 120. The minimization of disturbance of material flowing into inlet section 120 improves and enhances the accuracy of the particle measurement results.

Both inlet conduit 110 and outlet conduit 130 may be positioned within sleeve 100 in a variety of manners to form duct 108. Inlet conduit 110 and outlet conduit 130 may be positioned from in-line with each other on the same side of sleeve 100 (as shown in FIG. 2) to positioned on opposite sides of sleeve 100, and any angle in-between. Similarly, the inlet section 120 and outlet section 140 may be positioned axially in-line or axially offset, relative to each other. The axial distance between the conduit attachment points 110a and 130a is typically about 0 diameters (i.e., the same axial position) of sleeve 100 (if the attachment points are not axially in-line with each other) to 10 diameters of sleeve 100 (measured from the center of each conduit), with 0.1 to 1 diameter preferred and 0.25 diameters most preferred. The conduits are positioned within sleeve 100 for ease of placement of the inlet section 120 and outlet section 140 such that these sections do not make contact.

With reference to FIG. 2, when used in conjunction with a particle concentration and particle size measurement device 510, mill 520 and chute 530, the inlet section 120 is positioned in the flowpath of the material as it flows out of mill 520 and subsequently chute 530. A sample of the material then enters inlet conduit 110 via inlet section 120. Typically the sample size is less than 2% of the total material flowing through the present invention. Preferably, the sample size is less than 1% of the total material flowing through the present invention. The sampled material is typically aerosolized with compressed air to form a uni-particulate suspension (not shown). The suspended particles pass through a perpendicular laser beam in the optical head of the measurement device 510. The sample then exits the measurement device and enters the outlet conduit 130. The analyzed sample is subsequently returned to the flowpath via outlet conduit 130 and subsequently outlet section 140, which is also positioned in the flowpath, as described above.

Because the sample material is typically aerosolized (typically because of eductor pressure), the velocity of the sample flowing through the measurement device 510, outlet conduit 130 and outlet section 140 may be different from the velocity of the material flowing through duct 108. The sample may have a velocity greater than, less than or equal to the velocity of the material flowing through duct 108. The velocity of the sample flowing through outlet conduit 130 may be controlled by adjusting variables such as eductor air pressure, the length of inlet conduit 110, the length of outlet conduit 130 (in particular the length of bent portion 132 as well as the degree of bend) and the shape of the outlet section 140 and outlet port 142. Preferably, the sample has a velocity substantially equal to the velocity of the material flowing through duct 108 when the sample is returned to the flowpath to further minimize any disturbances of the material flowing through duct 108 because there is a higher negative pressure at inlet section 120 and a reduced disruption of flow of material through duct 108.

The sleeve 100, inlet conduit 110, inlet section 120, outlet conduit 130 and outlet section 140 can be made of any pharmaceutically inactive material. Typically, sleeve 100 inlet conduit 110, inlet section 120, outlet conduit 130 and outlet section 140 are made of stainless steel.

Although illustrated and described herein with reference to certain specific embodiments and examples, the present invention is nevertheless not intended to be limited to the details shown. Rather, the claims should be read to include various modifications within the scope and range of equivalents of the claims, without departing from the spirit of the invention.

What is claimed:

1. An inline sample extraction device, said device comprising:
a sleeve, having open ends and defining a duct adapted for insertion into a flowpath of a material and a sidewall;
an inlet conduit attached to said sleeve and having an inlet section at one end, wherein said inlet section defines an inlet port for withdrawing a sample of said material; and
an outlet conduit attached to said sleeve and having an outlet section at one end, wherein said outlet section has a portion extending substantially parallel to a direction of said material flowing in said flowpath and defines an outlet port for returning said sample of said material to said flowpath.

2. The device in accordance with claim 1 wherein said sleeve is cylindrical.

3. The device in accordance with claim 1, wherein;
said inlet conduit and said outlet conduit are cylindrical and protrude through said side wall of said sleeve; and
said inlet conduit and said outlet conduit are bent inside said duct, said inlet conduit is bent to face an upstream direction of said flowpath, and said outlet conduit is bent to face a downstream direction of said flowpath forming a bent portion of said outlet conduit adjacent said portion extending substantially parallel to said direction.

4. The device of claim 3, wherein the length of said portion extending substantially parallel to said direction is at least one diameter of said outlet conduit.

5. The device of claim 4, wherein the length of said portion extending substantially parallel to said direction is at least three diameters of said outlet conduit.

6. The device of claim 1, wherein the ratio of the cross section of said inlet port to said cross section of said duct is in the range of 1:5 to 1:100.

7. The device of claim 1, wherein the ratio of the cross section of said inlet port to said outlet port is in the range of 1:1 to 1:20.

8. The device of claim 1, wherein the ratio of the cross section of said inlet port to said outlet port is about 3:10.

9. The device of claim 2, wherein said inlet conduit and said outlet conduit are connected to said sleeve at angularly and axially offset positions.

10. The device of claim 9, wherein said inlet conduit and said outlet conduit are connected to said sleeve at an acute angle.

11. A system for testing a sample of a material flowing in a direction along a flowpath, said device comprising:
a sleeve, having open ends and defining a duct adapted for insertion in said flowpath of said material;
an inlet conduit attached to said sleeve and having an inlet section at one end, wherein said inlet section defines an inlet port for withdrawing said sample of said material;
an outlet conduit attached to said sleeve and having an outlet section at one end, wherein said outlet section has a portion extending substantially parallel to said direction and defines an outlet port for returning said sample of said material to said flowpath; and
an analyzer, connected between said inlet conduit and said outlet conduit, for determining at least one of the particle size and the particle concentration of said sample.

12. The device in accordance with claim 11 wherein said sleeve is cylindrical.

13. The device in accordance with claim 11, wherein;
said inlet conduit and said outlet conduit are cylindrical and protrude through said side wall of said sleeve; and
said inlet conduit and said outlet conduit are bent inside said duct, said inlet conduit is bent to face an upstream direction of said flowpath, and said outlet conduit is bent to face a downstream direction of said flowpath forming a bent portion of said outlet conduit adjacent said portion extending substantially parallel to said direction.

14. The device of claim 13, wherein the length of said portion extending substantially parallel to said direction is at least one diameter of said outlet conduit.

15. The device of claim 14, wherein the length of said portion extending substantially parallel to said direction is at least three diameters of said outlet conduit.

16. The device of claim 10, wherein the ratio of the cross section of said inlet port to said cross section of said duct is in the range of 1:5 to 1:100.

17. The device of claim 11, wherein the ratio of the cross section of said inlet port to said outlet port is in the range of 1:1 to 1:20.

18. The device of claim 11, wherein the ratio of the cross section of said inlet port to said outlet port is about 3:10.

19. The device of claim 12, wherein said inlet conduit and said outlet conduit are connected to said sleeve at angularly and axially offset positions.

20. The device of claim 19, wherein said inlet conduit and said outlet conduit are connected to said sleeve at an acute angle.

21. A method for bypassing a sample of a material flowing in a direction along a flowpath, said method comprising the steps of:
withdrawing said sample of said material from said flowpath; and
returning said sample to said flowpath in an outlet conduit having an outlet section, wherein said outlet section has a portion extending substantially parallel to said direction and defines an outlet port for returning said sample of said material to said flowpath.

22. The method of claim 21, wherein said sample is returned to said flowpath at a velocity higher than the velocity of said material flowing in said flowpath.

23. The method of claim 21, wherein said sample is returned to said flowpath at a velocity less than the velocity of said material flowing in said flowpath.

24. The method of claim 21, wherein said sample is returned to said flowpath at a velocity substantially equal to the velocity of said material flowing in said flowpath.

25. A method for testing a sample of a material flowing in a direction along a flowpath, said method comprising the steps of:
withdrawing said sample of said material from said flowpath;
analyzing said sample for determining at least one of (a) particle size and (b) particle concentration and of said sample; and
returning said sample to said flowpath in an outlet conduit having an outlet section, wherein said outlet section has a portion extending substantially parallel to said direction and defines an outlet port for returning said sample of said material to said flowpath.
